(19) United States
(12) Patent Application Publication
(10) Pub. No.: US 2026/0356208 A1
(43) Pub. Date: Nov. 12, 2026

(54) VEHICLE VIBRATION-DAMPING METHOD AND VEHICLE VIBRATION-DAMPING DEVICE

(71) Applicant: NISSAN MOTOR CO., LTD., Yokohama-shi, Kanagawa (JP)

(72) Inventors: Yuto INOUE, Kanagawa (JP); Hironobu KIKUCHI, Kanagawa (JP)

(21) Appl. No.: 19/135,483

(22) PCT Filed: Dec. 5, 2022
(86) PCT No.: PCT/JP2022/044692

§ 371 Date: Jun. 4, 2025

(51) Int. Cl. B60L 15/20; B60L 7/10

(52) U.S. Cl. CPC B60L 15/2009; B60L 7/10; B60L 2240/24; B60L 2240/423; B60L 2240/461

(57) ABSTRACT

A vehicle vibration-damping method is provided for reducing vibration of a vehicle capable of controlling a front wheel drive source configured to generate a driving force and a braking force on a front wheel and a rear wheel drive source configured to generate a driving force on a rear wheel independently of each other. The vehicle vibration-damping method includes, when temporal change in a steering angle associated with turning of the vehicle falls within a predetermined range, generating a braking force on the front wheel by the front wheel drive source, and generating, on the rear wheel, a driving force canceling all or a portion of the braking force on the front wheel by the rear wheel drive source.

### TECHNICAL FIELD

The present invention relates to a vehicle vibration-damping method and a vehicle vibration-damping device.

### BACKGROUND ART

In PTL 1 described below, a technology for suppressing a roll of a vehicle body by generating driving torque on a right front wheel, a left front wheel, a right rear wheel, and a left rear wheel independently of one another is described.

### CITATION LIST

### Patent Literature

PTL 1: JP 2005-312190 A

### SUMMARY OF INVENTION

### Technical Problem

However, there is a problem in that the configuration to control the right front wheel, the left front wheel, the right rear wheel, and the left rear wheel independently of one another causes an increase in weight and an increase in a cost due to increase in the number of components.

An object of the present invention is to reduce vibration in a yaw direction of a vehicle by controlling front wheel torque.

### Solution to Problem

According to an aspect of the present invention, there is provided a vehicle vibration-damping method for reducing vibration of a vehicle capable of controlling a front wheel drive source configured to generate a driving force and a braking force on a front wheel and a rear wheel drive source configured to generate a driving force on a rear wheel independently of each other, the vehicle vibration-damping method including: when temporal change in a steering angle associated with turning of the vehicle falls within a predetermined range, generating a braking force on the front wheel by the front wheel drive source; and generating, on the rear wheel, a driving force canceling all or a portion of the braking force on the front wheel by the rear wheel drive source.

### Advantageous Effects of Invention

According to an aspect of the present invention, it is possible to reduce vibration in a yaw direction of a vehicle by controlling front wheel torque.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a schematic configuration diagram of a vehicle including a vehicle vibration-damping device of an embodiment;

FIG. 2 is a block diagram of an example of a functional configuration of a controller;

FIG. 3 is a block diagram of an example of a functional configuration of a limiting coefficient calculation unit;

FIGS. 4A to 4D are explanatory diagrams of setting examples of limiting coefficients;

FIG. 5 is a block diagram of an example of a functional configuration of a target torque determination unit;

FIG. 6A is a schematic diagram of a vehicle body coordinate system and a front wheel coordinate system, and FIG. 6B is a schematic diagram of a front wheel braking force and a rear wheel driving force;

FIG. 7 is a schematic diagram of a simulation result; and

FIG. 8 is a flowchart of an example of a vehicle vibration-damping method of the embodiment.

### DESCRIPTION OF EMBODIMENTS

### (Configuration)

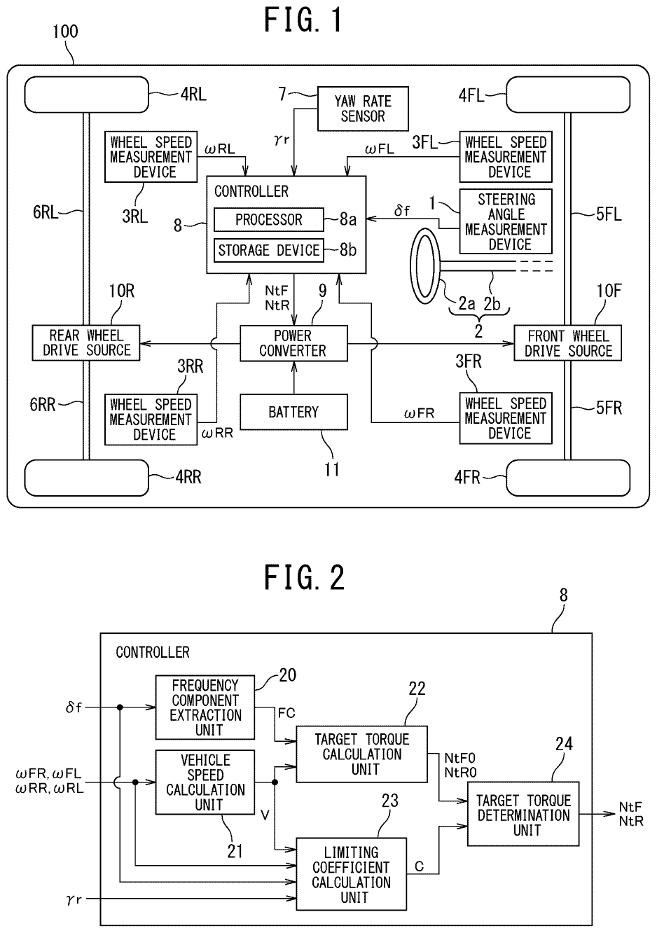

FIG. 1 is a schematic configuration diagram of a vehicle including a vehicle vibration-damping device of an embodiment. A vehicle 100 includes a steering angle measurement device 1, a steering device 2, wheel speed measurement devices 3FR, 3FL, 3RR, and 3RL, a right front wheel 4FR, a left front wheel 4FL, a right rear wheel 4RR, a left rear wheel 4RL, front wheel drive shafts 5FR and 5FL, rear wheel drive shafts 6RR and 6RL, a yaw rate sensor 7, a controller 8, a power converter 9, a front wheel drive source 10F, a rear wheel drive source 10R, and a battery 11. Note that in the following description, the right front wheel 4FR and the left front wheel 4FL are sometimes collectively referred to as “front wheels 4F” and the right rear wheel 4RR and the left rear wheel 4RL are sometimes collectively referred to as “rear wheels 4R”.

The steering angle measurement device 1 measures steering angle δf of a steering wheel 2a that turns steered wheels (that is, the front wheels 4F) for changing a traveling direction of the vehicle 100 and outputs the measured steering angle δf to the controller 8.

In the following description, a ratio Gstr=δf/θ of a rotation angle δf of the steering wheel 2a that a driver operates to a steered angle θ of the front wheels 4F with respect to the vehicle 100 is referred to as “steering gear ratio”. In a steer-by-wire system in which the steering wheel 2a and the front wheels 4F are mechanically separated from each other, the steering gear ratio Gstr can be controlled in a variable manner, and, for example, the steering gear ratio Gstr is determined according to the steering angle δf and a state of the vehicle 100. The steering angle measurement device 1 may measure the steered angle θ of the front wheels 4F in place of the steering angle δf of the steering wheel 2a. In this case, the steering angle δf is only required to be replaced by Gstr×(steered angle θ) in the following description.

In addition, when a steering assistance system by which the steered angle θ of the front wheels 4F is automatically controlled is installed in the vehicle 100, the steering angle measurement device 1 may acquire command values of a steering angle δf and a steered angle θ that the steering assistance system generates, in place of measured values of the steering angle δf and the steered angle θ.

In addition, the units of the physical quantities that the steering angle measurement device 1 acquires are not limited to an angle, and the steering angle measurement device 1 may detect angular velocity, which is a first-order time derivative of the steering angle δf or the steered angle θ, or angular acceleration, which is a second-order time derivative of the steering angle δf or the steered angle θ.

The steering device 2 includes the steering wheel 2a, a steering shaft 2b connected to the steering wheel 2a, and a steering mechanism (not illustrated) capable of changing an angle of the front wheels 4F with respect to the vehicle 100. The steering angle measurement device 1 is connected to the steering device 2 and measures change in an angle of the steering shaft 2b associated with rotation operation of the steering wheel 2a by the driver. In a general vehicle, rotation of the steering shaft 2b is converted to change in angles of the front wheels 4F with respect to the vehicle 100 by the steering device. On the other hand, in a steer-by-wire system, the steering shaft may be omitted.

The wheel speed measurement devices 3FR, 3FL, 3RR, and 3RL (hereinafter, sometimes collectively referred to as “wheel speed measurement devices 3”) measure wheel speeds ωFR, ωFL, ωRR, and ωRL of the right front wheel 4FR, the left front wheel 4FL, the right rear wheel 4RR, and the left rear wheel 4RL and outputs the measured wheel speeds ωFR, ωFL, ωRR, and ωRL to the controller 8, respectively. The front wheel drive shafts 5FR and 5FL are installed at positions corresponding to the right front wheel 4FR and the left front wheel 4FL and transmit both a driving force and a braking force that the front wheel drive source 10F generates to the right front wheel 4FR and the left front wheel 4FL, respectively. A rotational degree of freedom is provided between the front wheel drive shafts 5FR and 5FL and the front wheels 4F, which enables the steered angle θ of the front wheels 4F to be changed by the steering device 2. The rear wheel drive shafts 6RR and 6RL are installed at positions corresponding to the right rear wheel 4RR and the left rear wheel 4RL and transmit both a driving force and a braking force that the rear wheel drive source 10R generates to the right rear wheel 4RR and the left rear wheel 4RL, respectively. In a case of a vehicle having steerable rear wheels, a rotational degree of freedom is provided between the rear wheels 4R and the rear wheel drive shafts 6RR and 6RL, which enables the steered angle of the rear wheels 4R to be changed.

The yaw rate sensor 7 is fixed to a point where rigidity is comparatively high within the vehicle 100 and that is close to the center of gravity, and measures a yaw rate yr that is a time rate of change in a yaw angle of the vehicle 100 and outputs the measured yaw rate yr to the controller 8.

The controller 8 is an electronic control unit (ECU) that controls a driving force and a braking force generated on the front wheels 4F and a driving force and a braking force generated on the rear wheels 4R independently of each other. The controller 8 includes a processor 8a and a peripheral component, such as a storage device 8b. The processor 8a may be, for example, a central processing unit (CPU) or a micro-processing unit (MPU). The storage device 8b may include a semiconductor memory device, a magnetic storage device, an optical storage device, or the like. Functions of the controller 8, which will be described below, are achieved by, for example, the processor 8a executing computer programs stored in the storage device 8b.

The controller 8 determines target generation torque of the front wheel drive source 10F and target generation torque of the rear wheel drive source 10R, based on the steering angle δf, the wheel speeds ωFR, ωFL, ωRR, and ωRL, and the yaw rate γr acquired from the steering angle measurement device 1, the wheel speed measurement devices 3, and the yaw rate sensor 7, respectively and outputs the determined target generation torque to the power converter 9.

The power converter 9 converts power supplied from the battery 11, which is electrically connected to the power converter 9, to power to be supplied to the front wheel drive source 10F and the rear wheel drive source 10R in such a way as to achieve the target generation torque commanded by the controller 8. In addition, the front wheel drive source 10F and the rear wheel drive source 10R are used as generators, and regenerative power is supplied to the battery 11 through the power converter 9 and the battery 11 is charged by the regenerative power. Although in FIG. 1, a single power converter 9 is illustrated with respect to the front wheel drive source 10F and the rear wheel drive source 10R, the power converter 9 is capable of supplying power to the front wheel drive source 10F and the rear wheel drive source 10R independently of each other in such a way that the front wheel drive source 10F and the rear wheel drive source 10R can independently generate a driving force and a braking force.

The front wheel drive source 10F and the rear wheel drive source 10R generate both a driving force and a braking force on the front wheels 4F and the rear wheels 4R, respectively. For example, each of the front wheel drive source 10F and the rear wheel drive source 10R may include an electric motor and a reduction gear to which a rotation shaft of the electric motor is connected. The electric motor is connected to the power converter 9 and converts power supplied from the power converter 9 to rotational force of a rotor of the electric motor. Alternatively, the electric motor is used as a generator, and power is extracted from the rotational force and is used for charging the battery 11. The reduction gear converts rotational torque generated in the rotor to driving torque and braking torque to be exerted on the front wheel drive shafts 5FR and 5FL or the rear wheel drive shafts 6RR and 6RL by converting the revolution speed between the rotor and the front wheel drive shafts 5FR and 5FL or the rear wheel drive shafts 6RR and 6RL. Note that the power sources of the front wheel drive source 10F and/or the rear wheel drive source 10R are not limited to an electric motor and may be, for example, an internal-combustion engine.

FIG. 2 is a block diagram of an example of a functional configuration of the controller 8. The controller 8 includes a frequency component extraction unit 20, a vehicle speed calculation unit 21, a target torque calculation unit 22, a limiting coefficient calculation unit 23, and a target torque determination unit 24.

The frequency component extraction unit 20 extracts a frequency component FC of the steering angle δf. For example, the frequency component extraction unit 20 may calculate a time derivative value αf=dδf/dt of the steering angle δf and extract the frequency component FC by applying a low-pass filter to the time derivative value αf. A purpose of the application of the low-pass filter is to prevent high-frequency noise components included in an input signal from being amplified by the differential processing. A cutoff frequency fc1 of the low-pass filter processing may be set in such a way that high-frequency noise can be sufficiently removed and the cutoff frequency fc1 does not influence a yaw resonant frequency. Note that when a time rate of change is directly detected in the steering angle measurement device 1, the differential processing may be omitted.

In addition, the frequency component extraction unit 20 may, for example, extract a desired frequency component FC targeted in steering input by applying a band-pass filter to the steering angle δf. A low frequency-side cutoff frequency fc2 and a high frequency-side cutoff frequency fc3 of the band-pass filter are set in such a way that the target frequency exists between the cutoff frequencies and a sufficient gain in the passband can be achieved.

The vehicle speed calculation unit 21 calculates vehicle speed V that is gravity center velocity of the body of the vehicle 100, based on the wheel speeds ωFR, ωFL, ωRR, and ωRL. The vehicle speed calculation unit 21 calculates first vehicle speed VF=rF×ωF by multiplying an average wheel speed ωF=(ωFR+ωFL)/2 of the front wheels 4F by wheel radius rF of the front wheels 4F. In addition, the vehicle speed calculation unit 21 calculates second vehicle speed VR=rR×ωR by multiplying an average wheel speed ωR=(ωRR+ωRL)/2 of the rear wheels 4R by wheel radius rR of the rear wheels 4R. The vehicle speed calculation unit 21 obtains the vehicle speed V=(VF+VR)/2 by averaging the first vehicle speed VF and the second vehicle speed VR.

The target torque calculation unit 22 calculates a target braking torque amount NtF0 to be instructed to the front wheel drive source 10F. Specifically, the target torque calculation unit 22 calculates a torque of magnitude matching a rate of change in the yaw rate as the target braking torque amount NtF0. For example, the target torque calculation unit 22 calculates a target braking torque amount NtF0 of magnitude proportional to the rate of change in the yaw rate.

In this configuration, a yaw rate when the steering angle is in a steady state (hereinafter, referred to as “steady yaw rate γs”) is given by the formula (1) below, based on the equation of motion of a two-wheel model in which in each of the front wheels 4F and the rear wheels 4R, a right wheel and a left wheel are approximated by one wheel positioned at the center of an axle.

$$\begin{matrix}[ Math 1 ] & \\ γ s = \frac{V}{( 1 + {KV}^{2} ) l} \frac{δ f}{Gstr} & ( 1 )\end{matrix}$$

In the formula (1), the constant 1 denotes a wheelbase and the constant K denotes a stability factor. The target torque calculation unit 22 calculates the target braking torque amount NtF0 in accordance with the formula (2) below, based on the frequency component FC and the vehicle speed V. When the time derivative value αf=dδf/dt of the steering angle δf is extracted as the frequency component FC, the formula (2) is replaced by the formula (3) below.

$$\begin{matrix}[ Math 2 ] & \\ NtF 0 = - A \frac{V}{( 1 + {KV}^{2} ) l} \frac{\vert FC \vert}{Gstr} & ( 2 )\end{matrix}$$

$$NtF 0 = - A \frac{V}{( 1 + {KV}^{2} ) l} \frac{\vert α f \vert}{Gstr} \qquad ( 3 )$$

Note that the constant A in the formulae (2) and (3) is an arbitrary proportional constant gain and is determined in such a way that the target braking torque amount NtF0 is set to an appropriate value by use of simulation or an actual vehicle.

The formula (3) is obtained by replacing the time derivative value αf of the steering angle δf included in the formula (1) by an absolute value |αf|, assuming parameters other than αf as constants, multiplying the right-hand side of the resultant formula by the proportional constant gain A, and reversing the sign of the right-hand side of the resultant formula. Thus, the target braking torque amount NtF0 calculated based on the formula (3) has a value proportional to the rate of change of the yaw rate. Note that the reason why the absolute value |αf| is used is to generate the same control input regardless of whether the steering direction is positive or negative.

In addition, when a desired frequency component FC is extracted by applying a band-pass filter to the steering angle δf, the target braking torque amount NtF0 having a value proportional to the desired frequency component of the yaw rate can be obtained.

As described later, when a braking force is generated on the front wheels 4F when the vehicle 100 turns, a lateral force component in a direction opposite to a turning direction in which the front wheels 4F forms a turning angle with respect to the vehicle body is generated on the front wheels 4F. Thus, a yaw moment in a direction in which a yaw moment generated in the vehicle body due to steering associated with turning of the vehicle 100 is canceled can be generated, and it is possible to suppress gain (yaw rate gain) of a yaw rate response with respect to steering input. Because of this capability, it is possible to reduce vibration of the vehicle body in the yaw direction and stabilize vehicle behavior. In the following description, suppressing the yaw rate gain by generating a braking torque of the target braking torque amount NtF0 is sometimes referred to as “control intervention using the target braking torque amount NtF0”. In addition, in the present description, words “associated with turning of the vehicle” are used as a term meaning that an event occurs not only during turning of the vehicle but also when the vehicle transitions from a state of traveling straight to a state of turning or when the vehicle transitions from the state of turning to the state of traveling straight.

The target torque calculation unit 22 calculates a target driving torque amount NtR0 to be instructed to the rear wheel drive source 10R. For example, the target torque calculation unit 22 converts the target braking torque amount NtF0 to a braking force at tire-ground contact points of the front wheels 4F by multiplying the target braking torque amount NtF0 by a front-wheel drive system gear ratio GmotF and dividing the multiplication result by the wheel radius rF of the front wheels 4F. The target torque calculation unit 22 calculates a driving torque that generates a driving force canceling the braking force at tire-ground contact points of the rear wheels 4R as the target driving torque amount NtR0. For example, the target torque calculation unit 22 calculates the target driving torque amount NtR0 in accordance with the formula (4) below.

$$\begin{matrix}[ Math 3 ] & \\ NtR 0 = - \frac{GmotF}{GmotR} \frac{rR}{rF} NtF 0 & ( 4 )\end{matrix}$$

The constant GmotR in the formula (4) denotes a rear-wheel drive system gear ratio. Although in the example of the formula (4), the target driving torque amount NtR0 is calculated in such a way that the driving force generated in the rear wheels 4RF cancels all the braking force that the target braking torque amount NtF0 generates on the front wheels 4F, the target driving torque amount NtR0 may be calculated in such a way that the driving force cancels a portion of the braking force that the target braking torque amount NtF0 generates. That is, the driving force that the target driving torque amount NtR0 generates may be equal to, smaller or larger than the braking force that the target braking torque amount NtF0 generates.

The target torque calculation unit 22 outputs the target braking torque amount NtF0 and the target driving torque amount NtR0 to the target torque determination unit 24.

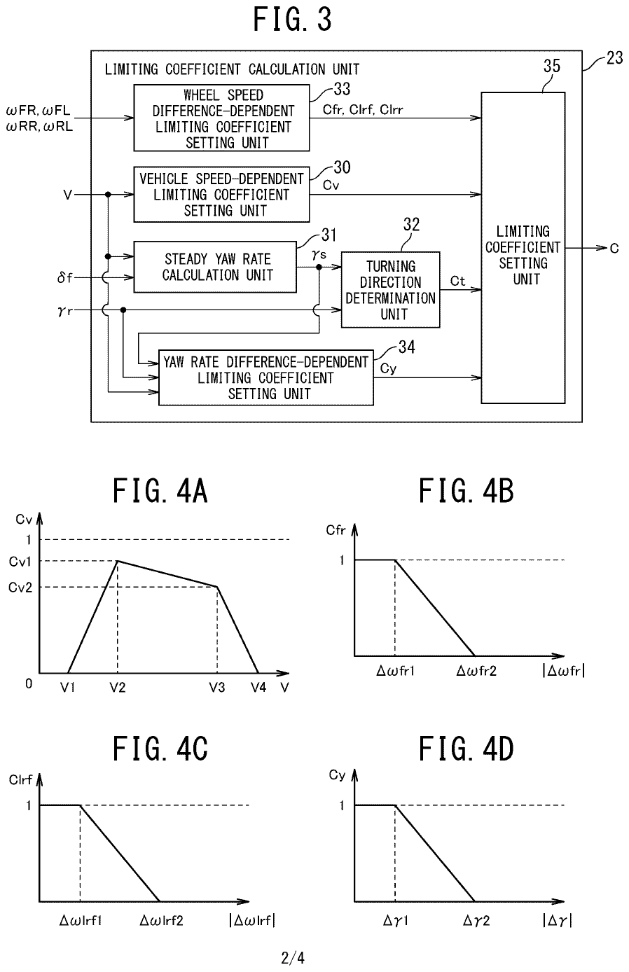

The limiting coefficient calculation unit 23 calculates a limiting coefficient C that limits the target braking torque amount NtF0 according to a vehicle state of the vehicle 100. FIG. 3 is a block diagram of an example of a functional configuration of the limiting coefficient calculation unit 23. The limiting coefficient calculation unit 23 includes a vehicle speed-dependent limiting coefficient setting unit 30, a steady yaw rate calculation unit 31, a turning direction determination unit 32, a wheel speed difference-dependent limiting coefficient setting unit 33, a yaw rate difference-dependent limiting coefficient setting unit 34, and a limiting coefficient setting unit 35.

The vehicle speed-dependent limiting coefficient setting unit 30 sets a vehicle speed-dependent limiting coefficient Cv according to vehicle speed.

FIG. 4A illustrates a setting example of the vehicle speed-dependent limiting coefficient Cv. The vehicle speed-dependent limiting coefficient Cv has a value in a range from “0” to “1”, and when the vehicle speed V is less than or equal to a threshold value V1 and when the vehicle speed V is greater than or equal to a threshold value V4, the vehicle speed-dependent limiting coefficient Cv is “0”. In a range where the vehicle speed V is the threshold value V1 or more and a threshold value V2 or less, the vehicle speed-dependent limiting coefficient Cv increases from “0” to a value Cv1 in association with increase in the vehicle speed V. In a range where the vehicle speed V is the threshold value V2 or more and a threshold value V3 or less, the vehicle speed-dependent limiting coefficient Cv changes from the value Cv1 to a value Cv2 in association with increase in the vehicle speed V. In a range where the vehicle speed V is the threshold value V3 or more and the threshold value V4 or less, the vehicle speed-dependent limiting coefficient Cv decreases from the value Cv2 to “0” in association with increase in the vehicle speed V.

It has been known that in general, in a frequency characteristic of the yaw rate response to steering input, when the vehicle speed V is low, a peak of the gain at the yaw resonant frequency is small and a phase of the yaw rate lags behind the steering input. Thus, performing control intervention using the target braking torque amount NtF0 in a low vehicle speed range causes a lag in a vehicle response behind the steering input to be promoted. Therefore, the threshold values V1 and V2 and the value Cv1 are determined in such a way that control intervention using the target braking torque amount NtF0 in the low vehicle speed range is eliminated or the target braking torque amount NtF0 becomes small. In addition, the threshold values V3 and V4 and the value Cv2 are values for setting a maximum vehicle speed at which the control intervention using the target braking torque amount NtF0 is performed and are set when an upper limit is set for the speed in consideration of durability. The threshold values V1 to V4 and the values Cv1 and Cv2 may be appropriately set based on, for example, specifications of the vehicle, simulation, and evaluation using the actual vehicle.

Note that although in the example in FIG. 4A, Cv1 and Cv2 are set in such a way that Cv1>Cv2 holds, Cv1 may be equal to or smaller than Cv2.

The steady yaw rate calculation unit 31 calculates a steady yaw rate γs, based on the steering angle δf, the vehicle speed V, and vehicle specifications. For example, the steady yaw rate calculation unit 31 may calculate the steady yaw rate γs in accordance with the above formula (1).

The turning direction determination unit 32 determines whether or not a turning direction calculated from steering operation of the driver coincides with a turning direction detected from the yaw rate γr detected by the sensor. The turning direction determination unit 32 outputs a determination result flag ct. When the turning direction calculated from the steering operation of the driver coincides with the turning direction detected from the yaw rate γr, the turning direction determination unit 32 sets a value αf the determination result flag ct to “1” and otherwise “0”. For example, when a sign of the yaw rate γr detected by the sensor and a sign of the steady yaw rate γs coincide with each other, the turning direction determination unit 32 sets the value of the determination result flag ct to “1” and otherwise “0”.

By determining the turning direction in this way, performing the control intervention using the target braking torque amount NtF0 and thereby suppressing the yaw rate gain only when the vehicle turning direction based on the target yaw rate estimated from steering operation of the driver and the vehicle turning direction based on an actual yaw rate of the vehicle 100 acquired by the sensor coincide with each other and conversely not suppressing the yaw rate gain when the turning directions do not coincide with each other enable behavior of the vehicle 100 to be prevented from lagging behind the operation of the driver.

The wheel speed difference-dependent limiting coefficient setting unit 33 sets a front-rear wheel speed difference-dependent limiting coefficient Cfr that limits the target braking torque amount NtF0 when a wheel speed difference Δωfr=ωF−ωR between the front wheels 4F and the rear wheels 4R is excessive (for example, when a slip occurs on the front wheels 4F and/or the rear wheels 4R). FIG. 4B illustrates a setting example of the front-rear wheel speed difference-dependent limiting coefficient Cfr. The front-rear wheel speed difference-dependent limiting coefficient Cfr has a value in a range from “0” to “1”. The front-rear wheel speed difference-dependent limiting coefficient Cfr is “1” when the wheel speed difference |Δωfr| is less than or equal to a threshold value Δωfr1, decreases from “1” to “0” as the wheel speed difference |Δωfr| increases when the wheel speed difference |Δωfr| falls within a range of the threshold value Δωfr1 or more and a threshold value Δωfr2 or less, and is “0” when the wheel speed difference |Δωfr| is greater than or equal to the threshold value Δωfr2. The threshold values Δωfr1 and Δωfr2 may be appropriately set based on the specifications of the vehicle, simulation, and evaluation using the actual vehicle.

The wheel speed difference-dependent limiting coefficient setting unit 33 sets a left-right wheel speed difference-dependent limiting coefficient Clrf that limits the target braking torque amount NtF0 when a wheel speed difference Δωlrf between the right front wheel 4FR and the left front wheel 4FL is excessive (for example, when a slip occurs on one of the right front wheel 4FR and the left front wheel 4FL). FIG. 4C illustrates a setting example of the left-right wheel speed difference-dependent limiting coefficient Clrf. The left-right wheel speed difference-dependent limiting coefficient Clrf has a value in a range from “0” to “1”. The left-right wheel speed difference-dependent limiting coefficient Clrf is “1” when the wheel speed difference |Δωlrf| is less than or equal to a threshold value Δωlrf1, decreases from “1” to “0” as the wheel speed difference |Δωlrf| increases when the wheel speed difference |Δωlrf| falls within a range of the threshold value Δωlrf1 or more and a threshold value Δωlrf2 or less, and is “0” when the wheel speed difference |Δωlrf| is greater than or equal to the threshold value Δωlrf2. The threshold values Δωlfr1 and Δωlrf2 may be appropriately set based on the specifications of the vehicle, simulation, and evaluation using the actual vehicle.

The wheel speed difference-dependent limiting coefficient setting unit 33, as with the method for setting the left-right wheel speed difference-dependent limiting coefficient Clrf, sets a left-right wheel speed difference-dependent limiting coefficient Clrr that limits the target braking torque amount NtF0 when a wheel speed difference Δωlrr between the right rear wheel 4RR and the left rear wheel 4RL is excessive (for example, when a slip occurs on one of the right rear wheel 4RR and the left rear wheel 4RL).

The yaw rate difference-dependent limiting coefficient setting unit 34 sets a yaw rate difference-dependent limiting coefficient Cy that limits the target braking torque amount NtF0 when a yaw rate difference Δγ=γs−γr between the steady yaw rate γs predictable from the steering operation of the driver and the yaw rate γr acquired by the yaw rate sensor 7 is excessive (for example, when a slip occurs on one or all of four wheels at the time of turning and the driver cannot turn the vehicle as desired). FIG. 4D illustrates a setting example of the yaw rate difference-dependent limiting coefficient Cy. The yaw rate difference-dependent limiting coefficient Cy has a value in a range from “0” to “1”. The yaw rate difference-dependent limiting coefficient Cy is “1” when the yaw rate difference |Δγ| is less than or equal to a threshold value Δγ1, decreases from “1” to “0” as the yaw rate difference |Δγ| increases when the yaw rate difference |Δγ| falls within a range of the threshold value Δγ1 or more and a threshold value Δγ2 or less, and is “0” when the yaw rate difference |Δγ| is greater than or equal to the threshold value Δγ2. The threshold values Δγ1 and Δγ2 may be appropriately set based on the specifications of the vehicle, simulation, and evaluation using the actual vehicle.

The limiting coefficient setting unit 35 selects a minimum value of the vehicle speed-dependent limiting coefficient Cv, the front-rear wheel speed difference-dependent limiting coefficient Cfr, the left-right wheel speed difference-dependent limiting coefficients Clrf and Clrr, and the yaw rate difference-dependent limiting coefficient Cy and calculates a product obtained by multiplying the selected minimum value by the determination result flag Ct as the limiting coefficient C=Ct×min(Cv, Cfr, Clrf, Clrr, Cy). The limiting coefficient setting unit 35 outputs the limiting coefficient C to the target torque determination unit 24.

The target torque determination unit 24 limits the target braking torque amount NtF0 and the target driving torque amount NtR0, which the target torque calculation unit 22 calculates, with the limiting coefficient C and thereby calculates a limited target braking torque amount NtF and a limited target driving torque amount NtR.

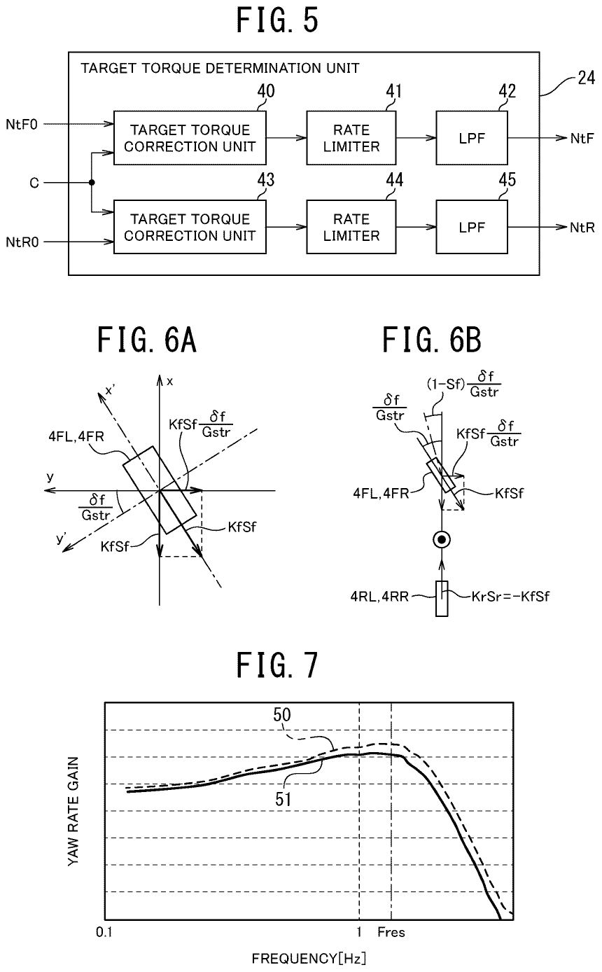

FIG. 5 is a block diagram of an example of a functional configuration of the target torque determination unit 24. The target torque determination unit 24 includes target torque correction units 40 and 43, rate limiters 41 and 44, and low-pass filters (LPFs) 42 and 45.

The target torque correction unit 40 calculates a product C×NtF0 obtained by multiplying the target braking torque amount NtF0 by the limiting coefficient C. The rate limiter 41 limits a time rate of change in the product C×NtF0. The target torque determination unit 24 applies the low-pass filter 42 having a cutoff frequency fc4 to output from the rate limiter 41 and thereby calculates the target braking torque amount NtF.

In addition, the target torque correction unit 43 calculates a product C×NtR0 obtained by multiplying the target driving torque amount NtR0 by the limiting coefficient C. The rate limiter 44 limits a time rate of change in the product C×NtR0. The target torque determination unit 24 applies the low-pass filter 45 having the cutoff frequency fc4 to output from the rate limiter 44 and thereby calculates the target driving torque amount NtR. In this processing, limiting values of rates of change of the rate limiters 41 and 44 and the cutoff frequency fc4 are set in such a way as not to influence a frequency band in which control is desired to be performed.

FIG. 1 is now referred to. The controller 8 outputs the target braking torque amount NtF and the target driving torque amount NtR to the power converter 9. The power converter 9 supplies the front wheel drive source 10F and the rear wheel drive source 10R with power in such a way as to achieve the target braking torque amount NtF and the target driving torque amount NtR, which are commanded by the controller 8. The front wheel drive source 10F and the rear wheel drive source 10R generate a braking force matching the target braking torque amount NtF and a driving force matching the target driving torque amount NtR on the front wheels 4F and the rear wheels 4R, respectively.

Next, a mechanism in which applying a braking torque that is determined during steering of the vehicle 100 as described before to the front wheels causes vehicle yaw behavior to be suppressed will be described. In the following description, it is assumed that the vehicle body has a shape symmetrical in the front-rear direction and in the right-left direction, and a two-wheel model in which in each of the front wheels 4F and the rear wheels 4R, the right wheel and the left wheel are approximated by one wheel positioned at the center of the axle is used.

FIG. 6A is a diagram illustrating a relationship between a vehicle body coordinate system and a front wheel coordinate system and a relationship between sets of axial components of a braking force each set of which is axial components viewed from one of the coordinate systems. The vehicle body coordinate system (solid line) is a coordinate system with a wheel center set as a coordinate system origin, an x-axis set in such a way that the x-axis is parallel with a vehicle body lateral center line and a direction toward the front is the positive direction, a y-axis set in such a way that the y-axis is orthogonal to the x-axis and the left direction is the positive direction, and a z-axis set in such a way as to form a right-handed system with the x-axis and the y-axis. The front wheel coordinate system (dashed-dotted line) is a coordinate system with the wheel center set as a coordinate system origin, an x-axis set in such a way that the x-axis is parallel with a longitudinal direction of the wheels and a direction toward the front is the positive direction, a y-axis set in such a way that the y-axis is orthogonal to the x-axis and the left direction is the positive direction, and a z-axis set in such a way as to form a right-handed system with the x-axis and the y-axis.

The vehicle body coordinate system and the front wheel coordinate system have the origin in common. A case is assumed where the front wheel coordinate system (dashed-dotted line) is rotated about the wheel center in a counterclockwise direction by δf/Gstr with respect to the vehicle body coordinate system (solid line). The case indicates a state in which the front wheels 4F are turned by δf/Gstr with respect to the vehicle body.

A braking force is calculated as a product Kf×Sf of a front wheel slip ratio Sf and a front wheel traction coefficient Kf. The front wheel slip ratio Sf=(rF×ωF−V)/V is obtained by dividing a difference between a product of the wheel speed ωF of the front wheels 4F and the wheel radius rF of the front wheels 4F and an x-direction component of the vehicle speed V by the vehicle speed V. A braking force in an actual vehicle takes a certain amount of time to generate a front wheel slip ratio Sf with respect to a braking torque instructed to a motor. Although for this reason, a delay occurs for a braking force Kf×Sf balanced with the target braking torque amount NtF to be generated, the delay is sufficiently small compared with frequency of steering angle change (that is, frequency of yaw behavior of the vehicle) and influence of the delay is thus negligible.

Although the braking force Kf×Sf acts in the x-axis direction of the front wheel coordinate system, the front wheels 4F being turned by the turning angle δf/Gstr with respect to the vehicle body causes the braking force Kf×Sf to include a y-axis component (Kf×Sf×sin(δf/Gstr)≈Kf×Sf×δf/Gstr) in the vehicle body coordinate system. A direction of the y-axis component (Kf×Sf×δf/Gstr) is an opposite direction to the turning direction. Thus, when a braking force is generated on the front wheels 4F at the time of steering, a yaw moment in a direction in which a yaw moment generated in the vehicle body by the steering is canceled can be generated. Since on this occasion, a braking force (Kf×Sf×cos(δf/Gstr)≈Kf×Sf) is generated on the front wheels 4F in the negative direction of the x-axis of the vehicle body coordinate system, longitudinal acceleration occurs. In order to prevent or reduce deceleration of the vehicle 100 due to the braking force on the front wheels 4F, a driving force Kr×Sr=−Kf×Sf of the target driving torque amount NtR is generated on the rear wheels 4R, as illustrated in FIG. 6B. Kr and Sr denote a rear wheel traction coefficient and a rear wheel slip ratio, respectively.

A simulation result when a front wheel braking torque is provided according to steering angular velocity αf=dδf/dt is described below. FIG. 7 illustrates a frequency characteristic of gain of a yaw rate response to steering input. A dashed line 50 indicates a comparative example of the gain when no front wheel braking torque is provided, and a solid line 51 indicates the gain when a front wheel braking torque is provided. As can be inferred from FIG. 7, while around 0 Hz where the steering angular velocity is comparatively low, a difference in the gain between the case where no front wheel braking torque is provided and the case where a front wheel braking torque is provided is small, providing a front wheel braking torque causes a peak to be suppressed around a yaw resonant frequency Fres. It is revealed that because of this simulation result, change in the magnitude of a yaw response of the vehicle body between at the time of steering by the driver around the yaw resonant frequency Fres and at the time of steady steering around 0 Hz is suppressed compared with the case where no front wheel braking torque is provided.

It has been known that in general, vehicle characteristics where change in the frequency response of the yaw rate gain is small increase a sense of stability in a sensory test, and therefore, the present invention improves stability with respect to steering at the time of high speed travel, where a resonance peak increases.

Although in the present invention, the target braking torque amount NtF is set by multiplying the steering angular velocity αf=dδf/dt by a gain, this configuration means that the higher the frequency of steering input is, the larger the target braking torque amount NtF becomes in proportion to angular frequency of the steering input. Therefore, when the gain is set in such a way that the yaw rate gain decreases to a desired value at the yaw resonant frequency Fres, vibration damping effect by use of a lateral force generated by braking can be increased.

In addition, setting the target braking torque amount NtF matching the steering angular velocity αf=dδf/dt causes the vibration damping effect to be increased as the steering includes a higher frequency component. Likewise, setting the target braking torque amount NtF based on a component extracted by applying a band-pass filter to the steering angle δf enables the yaw rate gain in an arbitrary frequency band to be reduced.

### (Operation)

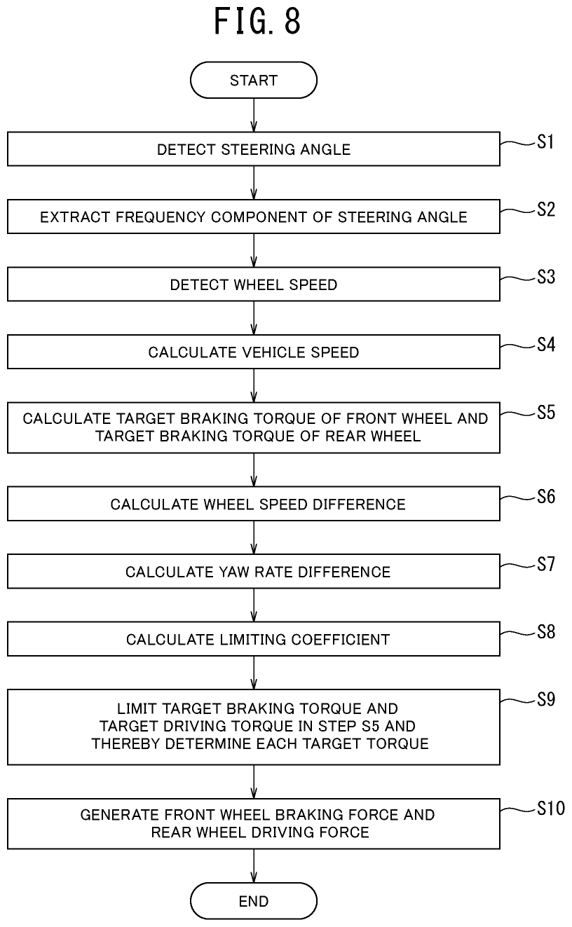

FIG. 8 is a flowchart of an example of a vehicle vibration-damping method of the embodiment.

In step S1, the steering angle measurement device 1 detects a steering angle δf of the steering wheel 2a. In step S2, the frequency component extraction unit 20 extracts a frequency component FC of the steering angle δf. In step S3, the wheel speed measurement devices 3FR, 3FL, 3RR, and 3RL detect wheel speeds ωFR, ωFL, ωRR, and ωRL, respectively. In step S4, the vehicle speed calculation unit 21 calculates vehicle speed V, based on the wheel speeds ωFR, ωFL, ωRR, and ωRL.

In step S5, the target torque calculation unit 22 calculates a target braking torque amount NtF0, based on the frequency component FC and the vehicle speed V. In addition, the target torque calculation unit 22 calculates a target driving torque amount NtR0 that generates, on the rear wheels 4R, a driving force canceling all or a portion of a braking force generated on the front wheels 4F by the target braking torque amount NtF0. In step S6, the limiting coefficient calculation unit 23 calculates wheel speed differences Δωfr, Δωlrf, and Δωlrr. In step S7, the limiting coefficient calculation unit 23 calculates a yaw rate difference Δγ. In step S8, the limiting coefficient calculation unit 23 calculates a limiting coefficient C, based on the vehicle speed V, the wheel speed differences Δωfr, Δωlrf, and Δωlrr, the yaw rate difference Δγ, a yaw rate γr detected by the sensor, and a steady yaw rate γs calculated from steering operation.

In step S9, the target torque determination unit 24 limits the target braking torque amount NtF0 and the target driving torque amount NtR0 that are calculated in step S5 with the limiting coefficient C and thereby calculates a limited target braking torque amount NtF and a limited target driving torque amount NtR. In step S10, the power converter 9, the front wheel drive source 10F, and the rear wheel drive source 10R generate a braking force matching the target braking torque amount NtF and a driving force matching the target driving torque amount NtR on the front wheels 4F and the rear wheels 4R, respectively. Subsequently, the process terminates.

### (Advantageous Effects of Embodiment)

(1) The controller 8 reduces vibration of the vehicle 100 capable of controlling the front wheel drive source configured to generate a driving force and a braking force on the front wheels 4F and the rear wheel drive source configured to generate a driving force on the rear wheels 4R independently of each other. When temporal change in the steering angle associated with turning of the vehicle 100 falls within a predetermined range, the controller 8 generates a braking force on the front wheels 4F by the front wheel drive source and generates, on the rear wheels 4R, a driving force canceling all or a portion of the braking force on the front wheels 4F by the rear wheel drive source.

The braking force generated on the front wheels 4F has a lateral force component with respect to the vehicle body due to the front wheels 4F being turned. By generating such a lateral force component in accordance with turning motion of the vehicle body due to steering, it is possible to generate a yaw moment in the reverse direction to the turning direction and control the yaw rate without performing torque control on a right wheel and a left wheel independently of each other. In addition, providing the rear wheels 4R with a driving torque that generates a driving force balanced with a braking force generated on the front wheels 4F enables acceleration and deceleration in the vehicle body longitudinal direction to be suppressed.

(2) The controller 8 may generate a braking force proportional to a time derivative of the steering angle on the front wheels.

Because of this configuration, the higher frequency component the steering has, the better a motion in the yaw direction of the vehicle 100 with respect to the steering angle can be suppressed. When a difference in the yaw rate gain between the yaw resonant frequency and 0 Hz (that is, steady steering angle input) is small, vibration damping properties in the yaw motion are high. When vibration of a motion in the yaw direction is damped using a lateral force caused by a front wheel braking force proportional to a time derivative of a steering angle, the higher frequency component the steering input has (that is, the more rapidly the steering is performed), the larger vibration damping effect proportional to an angular frequency of the input can be obtained. As a result, not generating a front wheel braking force to steady steering angle input while reducing the yaw rate gain at a yaw resonant frequency enables vibration damping of the yaw motion by reduction in a yaw rate gain difference to be achieved.

(3) The controller 8 may generate a braking force proportional to the magnitude of a predetermined frequency component of the steering angle on the front wheels.

Because of this configuration, it is possible to provide front wheel braking input proportional to a frequency component that is extracted by applying a band-pass filter, the band-pass filter extracting a frequency component around a yaw resonant frequency, to a time component of an input of a steering angle. As a result, vibration damping of the yaw motion that, while suppressing a peak value of the yaw rate gain exclusively around the yaw resonant frequency, does not influence the yaw rate gain in the other frequency band can be achieved.

(4) The controller 8 may limit at least a braking force according to speed of the vehicle 100. Because of this configuration, limiting a braking torque exerted on the front wheels 4F when the speed of the vehicle 100 is low enables excessive vibration damping at a low speed to be prevented. In general, a difference in the yaw rate gain between at the time of steady steering and at the time of steering around a yaw resonant frequency becomes more prominent as the speed of the vehicle 100 increases and becomes small when the speed is low. Thus, when a front wheel braking force is generated when comparatively rapid steering is performed while the vehicle is traveling at a low speed, there is a possibility that steering responsiveness is harmed. Therefore, by limiting the front wheel braking force when the vehicle speed is low and increasing the front wheel braking force as the vehicle speed increases, it is possible to increase the vibration damping effect at the time of high-speed traveling without harming steering responsiveness at a low speed.

(5) The controller 8 may limit the magnitude of the amount of temporal change in a braking force. Because of this configuration, by limiting temporal variation in the target braking torque amount NtF0 when the target braking torque amount NtF0 temporally varies, a rapid change in behavior of the vehicle 100 can be suppressed.

(6) The controller 8 may limit at least a braking force when a direction of change in the steering angle and a turning direction of the vehicle 100 are different. Because of this configuration, it is possible to prevent the driver from feeling that the vehicle does not turn as intended when a direction in which the driver intends to travel and a movement direction of the vehicle are different.

(7) The controller 8 may limit at least a braking force when a difference in the revolution speed between the front wheels 4F and the rear wheels 4R exceeds a first threshold value.

Because of this configuration, it is possible to limit the front wheel braking force when an excessive slip occurs on one or both of the front wheels 4F and the rear wheels 4R due to generation of the target braking torque amount NtF. Because of this configuration, by reducing slip of the four wheels, it is possible to prevent the behavior of the vehicle from being destabilized.

(8) The controller 8 may limit at least a braking force when a difference in the revolution speed between a right wheel and a left wheel exceeds a second threshold value.

Because of this configuration, it is possible to limit the front wheel braking force when an excessive slip occurs on one of the right wheel and the left wheel of the front wheels 4F or one of the right wheel and the left wheel of the rear wheels 4R or when in both the front wheels 4F and the rear wheels 4R, an excessive slip occurs on one of the right wheel and the left wheel at the same time, due to generation of the target braking torque amount NtF. Because of this configuration, by reducing slips of the four wheels, it is possible to prevent the behavior of the vehicle from being destabilized.

(9) When a difference between a yaw rate calculated based on at least a steering angle and a yaw rate detected by a sensor exceeds a third threshold value, at least a braking force may be limited.

Because of this configuration, it is possible to limit the front wheel braking force when a slip occurs on one or all of the four wheels due to generation of the target braking torque amount NtF and the driver cannot turn the vehicle as desired. Because of this configuration, by reducing slip of the four wheels, it is possible to prevent the behavior of the vehicle from being destabilized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

1 Steering angle measurement device
2 Steering device
2a Steering wheel
2b Steering shaft
3 Wheel speed measurement device
3FL, 3FR, 3RL, 3RR Wheel speed measurement device
4F Front wheel
4FL Left front wheel
4FR Right front wheel
4R Rear wheel
4RF Rear wheel
4RL Left rear wheel
4RR Right rear wheel
5FL Front wheel drive shaft
5FR Front wheel drive shaft
6RL Rear wheel drive shaft
6RR Rear wheel drive shaft
7 Yaw rate sensor
8 Controller
8a Processor
8b Storage device
9 Power converter
10F Front wheel drive source
10R Rear wheel drive source
11 Battery
20 Frequency component extraction unit
21 Vehicle speed calculation unit
22 Target torque calculation unit
23 Limiting coefficient calculation unit
24 Target torque determination unit
30 Vehicle speed-dependent limiting coefficient setting unit
31 Steady yaw rate calculation unit
32 Turning direction determination unit
33 Wheel speed difference-dependent limiting coefficient setting unit
34 Yaw rate difference-dependent limiting coefficient setting unit
35 Limiting coefficient setting unit
40, 43 Target torque correction unit
41, 44 Rate limiter
42, 45 Low-pass filter (LPF)
100 Vehicle

1. A vehicle vibration-damping method for reducing vibration of a vehicle capable of controlling a front wheel drive source configured to generate a driving force and a braking force on a front wheel and a rear wheel drive source configured to generate a driving force on a rear wheel independently of each other, the vehicle vibration-damping method comprising:
when temporal change in a steering angle associated with turning of the vehicle falls within a predetermined range, generating a braking force on the front wheel by the front wheel drive source; and
generating, on the rear wheel, a driving force canceling all or a portion of the braking force on the front wheel by the rear wheel drive source.

2. The vehicle vibration-damping method according to claim 1, wherein the vehicle vibration-damping method generates the braking force proportional to a time derivative of the steering angle on the front wheel.

3. The vehicle vibration-damping method according to claim 1, wherein the vehicle vibration-damping method generates the braking force proportional to magnitude of a predetermined frequency component of the steering angle on the front wheel.

4. The vehicle vibration-damping method according to claim 1 comprising limiting at least the braking force according to speed of the vehicle.

5. The vehicle vibration-damping method according to claim 1 comprising limiting magnitude of an amount of temporal change in the braking force.

6. The vehicle vibration-damping method according to claim 1 comprising limiting at least the braking force when a direction of change in the steering angle and a turning direction of the vehicle are different.

7. The vehicle vibration-damping method according to claim 1 comprising limiting at least the braking force when a difference in a revolution speed between the front wheel and the rear wheel exceeds a first threshold value.

8. The vehicle vibration-damping method according to claim 1 comprising limiting at least the braking force when a difference in a revolution speed between a right wheel and a left wheel exceeds a second threshold value.

9. The vehicle vibration-damping method according to claim 1 comprising limiting at least the braking force when a difference between a yaw rate calculated based on at least the steering angle and a yaw rate detected by a sensor exceeds a third threshold value.

10. A vehicle vibration-damping device configured to reduce vibration of a vehicle, the vehicle vibration-damping device comprising:
a front wheel drive source configured to generate a driving force and a braking force on a front wheel;
a rear wheel drive source configured to generate a driving force on a rear wheel independently of a driving force and a braking force generated on the front wheel; and
a controller configured to, when temporal change in a steering angle associated with turning of the vehicle falls within a predetermined range, execute processing including: generating a braking force on the front wheel by the front wheel drive source; and generating, on the rear wheel, a driving force canceling all or a portion of the braking force on the front wheel by the rear wheel drive source.
